(19) United States
(12) Patent Application Publication
(10) Pub. No.: US 2019/0206200 A1
(43) Pub. Date: Jul. 4, 2019

(54) Method and device of custom vibration sense

(71) Applicant: AAC Technologies Pte. Ltd., Singapore city (SG)

(72) Inventors: Yao Wang, Shenzhen (CN); Rui Wu, Shenzhen (CN)

(21) Appl. No.: 16/056,674

(22) Filed: Aug. 7, 2018

(30) Foreign Application Priority Data
Dec. 29, 2017 (CN) 201711479991.6

(51) Int. Cl. G08B 6/00

(52) U.S. Cl. CPC G08B 6/00; G06F 3/04883

(57) ABSTRACT

The present disclosure discloses a method of custom vibration sense including the following steps: obtaining a figure drawn by users on a screen; obtaining a vibration characteristic physical quantity for characterizing the vibration sense according to the figure; generating an electrical signal for driving a motor according to the vibration characteristic physical quantity; storing or playing the electrical signal as a custom vibration sense correspond with the figure. The present disclosure further provides a device of custom vibration sense. The method and device of custom vibration sense can provide a custom vibration sense with different vibration intensity.

### FIELD OF THE PRESENT DISCLOSURE

The present disclosure generally relates to electronic device, and more particularly, to a method and device of custom vibration sense.

### DESCRIPTION OF RELATED ART

For now, in intelligent terminal devices, there are seven kinds of vibration signals (staccato, symphony, accent, speed, reminder, heartbeat, SOS) for users to choose from. However, when the vibration signals are used after a long time, several kinds of the vibration signals can no longer satisfy users' experience needs. In order to make users have a better experience when using intelligent terminal devices, the function of custom vibration sense has appeared. In prior art, the method for realizing custom vibration sense is as follows: in a period of time, users create vibration signal with different rhythm by pressing and releasing a screen, that is, when users pressed, the screen vibrates, and when users released, the screen not vibrate.

Inventor found that at least the following problems existed in prior art: users create vibration signal with different rhythm by pressing and releasing a screen, that is essentially the combination of vibrations with different length of time. Due to only one kind of vibration signal used in above process, that result, in each period of time, the length of vibration is different and the intensity of vibration is exactly the same.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a flow diagram of a method of custom vibration sense in accordance with a first embodiment of the present disclosure;

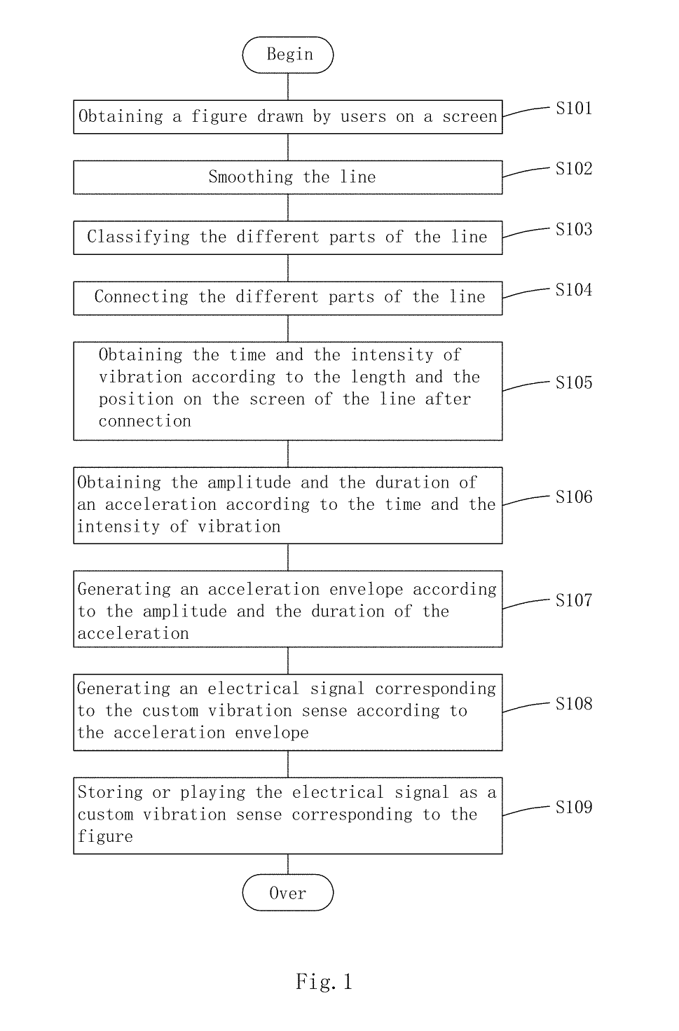

FIG. 2 shows the waveform of a first acceleration in accordance with the first embodiment of the present disclosure;

FIG. 3 shows a custom curve in accordance with the first embodiment of the present disclosure;

FIG. 4 shows the waveform of an acceleration corresponding to the custom curve in accordance with the FIG. 3;

FIG. 5 shows a custom straight line in accordance with the first embodiment of the present disclosure;

FIG. 6 shows the waveform of an acceleration corresponding to the straight line 1 in accordance with the FIG. 5;

FIG. 7 shows the waveform of an acceleration corresponding to the straight line 2 in accordance with the FIG. 5;

FIG. 8 shows a combination line 1 in accordance with the first embodiment of the present disclosure;

FIG. 9 shows the waveform of an acceleration corresponding to the combination line 1 in accordance with the FIG. 8;

FIG. 10 shows the combination line 2 in accordance with the first embodiment of the present disclosure;

FIG. 11 shows the waveform of an acceleration corresponding to the combination line 2 in accordance with the FIG. 10;

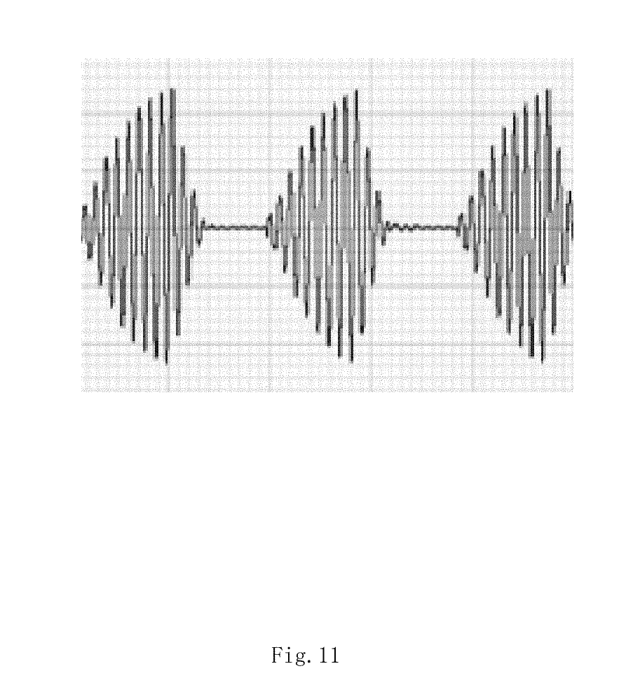

FIG. 12 is a flow diagram of a method of custom vibration sense in accordance with a second embodiment of the present disclosure;

FIG. 13 shows the waveform of an electrical signal corresponding to the custom curve in accordance with the FIG. 3;

FIG. 14 is schematic diagram of a device of custom vibration sense in accordance with a third embodiment of the present disclosure.

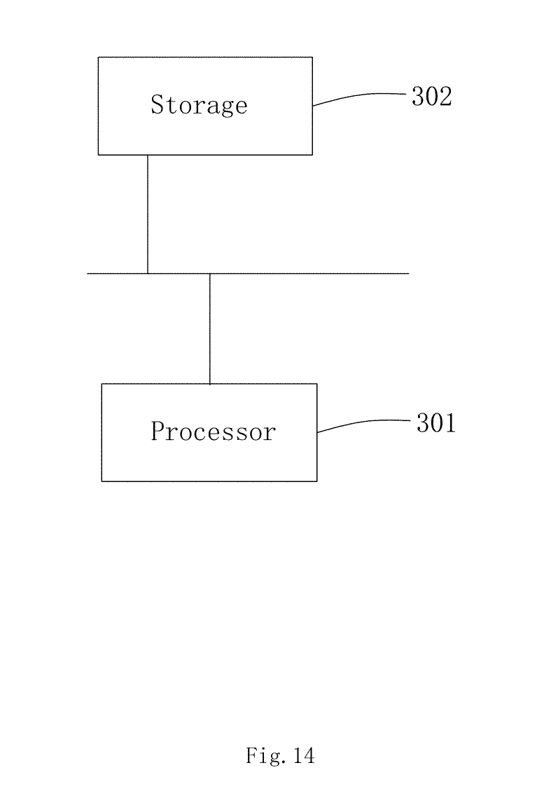

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

Embodiment 1 of the present disclosure relates to a method of custom vibration sense, the core in embodiment 1 is to: obtain a figure drawn by users on a screen; obtain a vibration characteristic physical quantity for characterizing the vibration sense according to the figure; generate an electrical signal for driving a motor according to the vibration characteristic physical quantity; store or play the electrical signal as a custom vibration sense correspond with the figure. The method of custom vibration sense of this embodiment will hereinafter be described in detail.

S101: obtaining a figure drawn by users on a screen.

Specifically, in the step S101, the figure is illustrated as a line, users draw a line on the screen, the line may be one or more of point, straight line, curve or polyline, and users can freely combine the lines by preference, for example, the combination of straight line and straight line, the combination of straight line and curve, and so on. Of course, it is to be understood that, the figure can be other figure, such as bar chart, sector chart, and so on, just to name a few.

S102: smoothing the line.

Specifically, in the step S102, the line can be processed by using a mean filter, there is to give a template for target pixels on the line, the template includes adjacent pixels surrounding itself (a filtering template is constituted by eight pixels surrounding the center of the target pixels, the target pixels has been removed), then, the original pixels value is replaced by the average value of the whole pixels in the template. The abrupt gradient of the line decreases and the quality of the line improves.

S103: classifying the different parts of the line.

Specifically, in the step S103, in order to execute the next steps, straight line are classified with straight line, curve are classified with curve.

S104: connecting the different parts of the line.

S105: obtaining the time and the intensity of vibration according to the length and the position on the screen of the line after connection.

Specifically, in the step S105, the length of the line is correspond with the time of vibration, for example, one centimeter means 500 milliseconds. Therefore, if users drawn a four centimeters line, that means the time of vibration is two seconds. The position of the line on the screen is corresponding to the intensity of vibration, the intensity of vibration can be determined through the different position on the screen of the starting point of the line. It is to be understood that, users can pre-set the intensity of vibration correspond with different positions of the screen according to their needs, in order to generate a completely different vibration experience.

S106: obtaining the amplitude and the duration of an acceleration according to the time and the intensity of vibration.

S107: generating an acceleration envelope according to the amplitude and the duration of the acceleration.

Specifically, in the step S107, the waveform is drawn through the functional relation of the amplitude and the duration of the acceleration, and the acceleration envelope is generated by finding the geometric position of each point in the phase and connecting the trajectories of these points.

S108: generating an electrical signal corresponding to the custom vibration sense according to the acceleration envelope.

Specifically, in the step S108, the electrical signal can be generated through the acceleration envelope, also can be generated through the combination of the acceleration envelope, a motor and other characteristic physical quantity of the motor system. Due to the electrical signal is voltage or electricity which changes over time, thus the electrical signal can represent as a functional relationship of time and the waveform of the electrical signal can be drawn. Due to the change rule of the electrical signal waveform is corresponding with the change rule of the figure drawn by users, through the electrical signal drives the motor, the variation of vibration intensity over time can be perceived more directly by the waveform of the electrical signal.

S109: storing or playing the electrical signal as a custom vibration sense corresponding to the figure.

Specifically, in the step S109, the figure is illustrated as curve, when the curve is compressed and the length is long, the variation of vibration is slow and the amplitude of vibration is small. When the curve is short and the peak of the curve is high, the variation of the vibration is drastic. Therefore, for a straight line, the slope of the straight line is different, the feeling of the enhancement of vibration is also different.

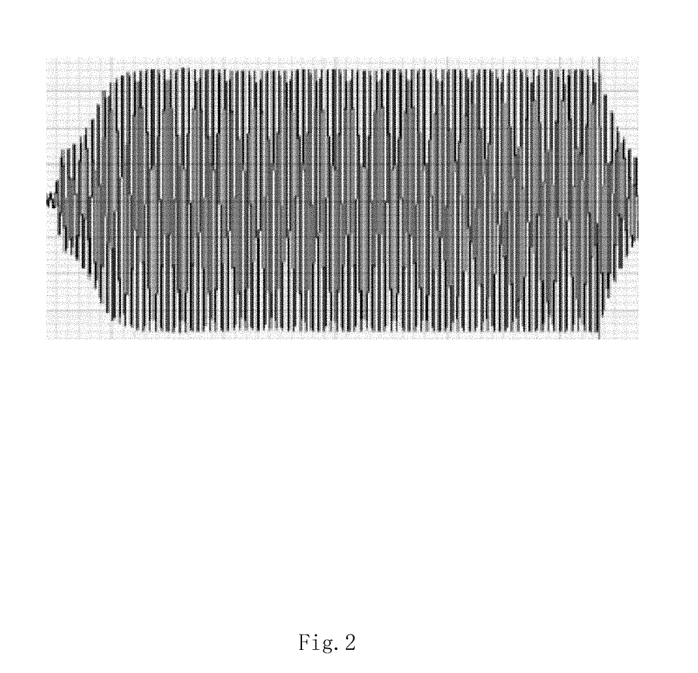

The effect of the embodiment 1 of the present disclosure hereinafter is described in detail. For normal vibration signals, the waveform figure of a first acceleration is shown in FIG. 2. Users mainly feel the process of steady vibration in the middle, that is, the vibration is invariable and the intensity of vibration is stable, this is also the most common vibration form.

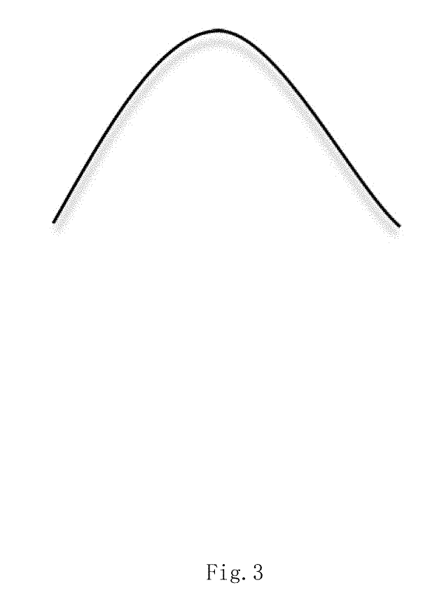

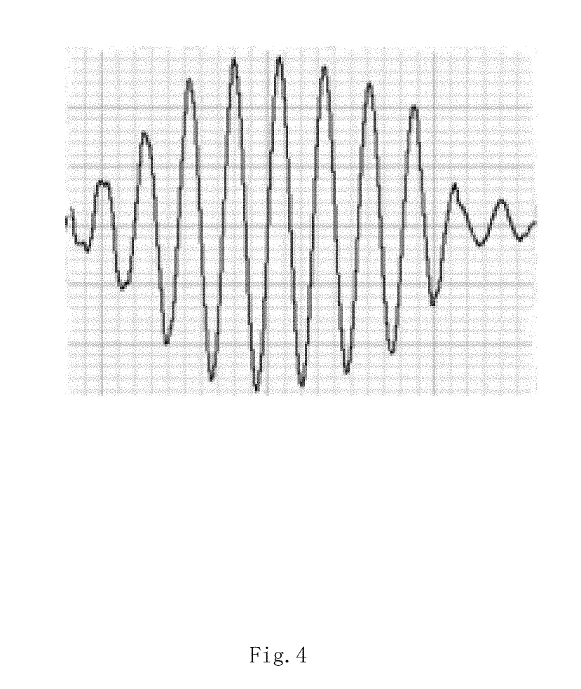

When the line drawn by users is curve as shown in FIG. 3, the waveform figure of an acceleration shown in FIG. 4 is generated through the function relationship of the amplitude and duration of the acceleration, it can clearly feel the process of symmetrical rising and falling of the intensity of vibration.

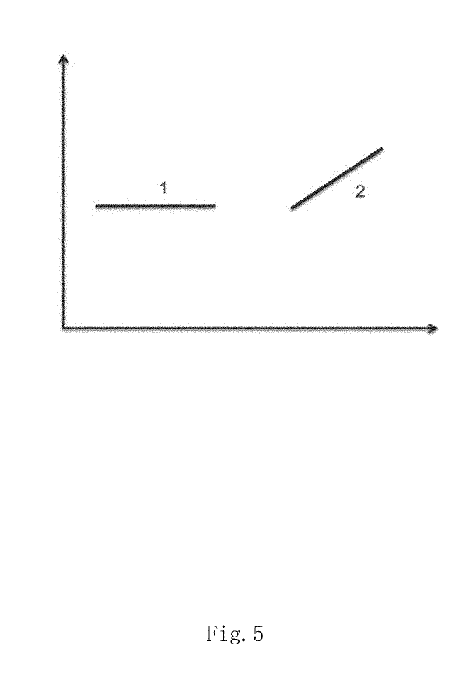

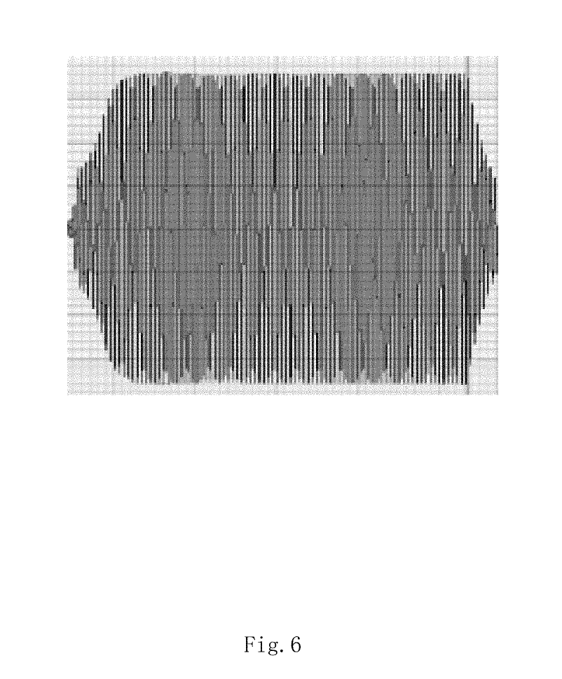

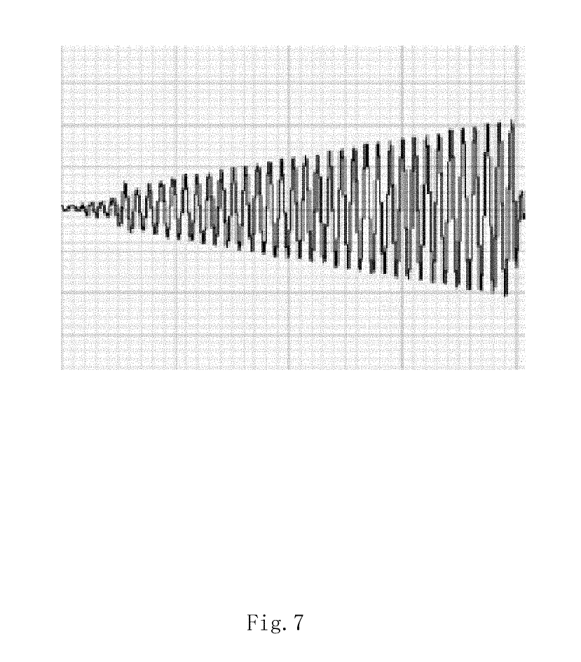

When the line drawn by users is the line 1 as shown in FIG. 5, the waveform figure of an acceleration shown in FIG. 6 is generated through the function relationship of the amplitude and duration of the acceleration. Due to the line 1 is a horizontal straight line, the vibration sense is invariable, and users will not feel the change of the vibration intensity over time. When the line drawn by users is the line 2 as shown in FIG. 5, the waveform figure of an acceleration as shown in FIG. 7 is generated through the function relationship of the amplitude and duration of the acceleration. Due to the line 2 is an upward sloping line, the vibration sense will show a linear growth trend over time, and users will feel the vibration sense more and more strong. Obviously, when the slope of a straight line is different, the feeling of the enhancement of the vibration is also different. Hence, linear type also has a variety of different types of vibration sense.

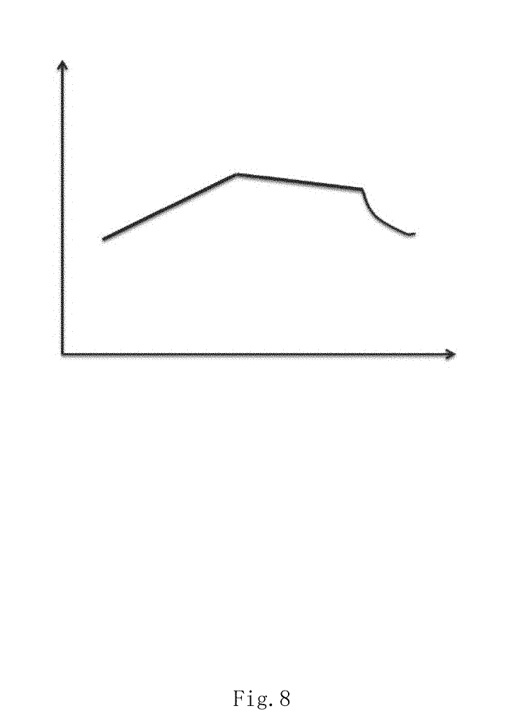

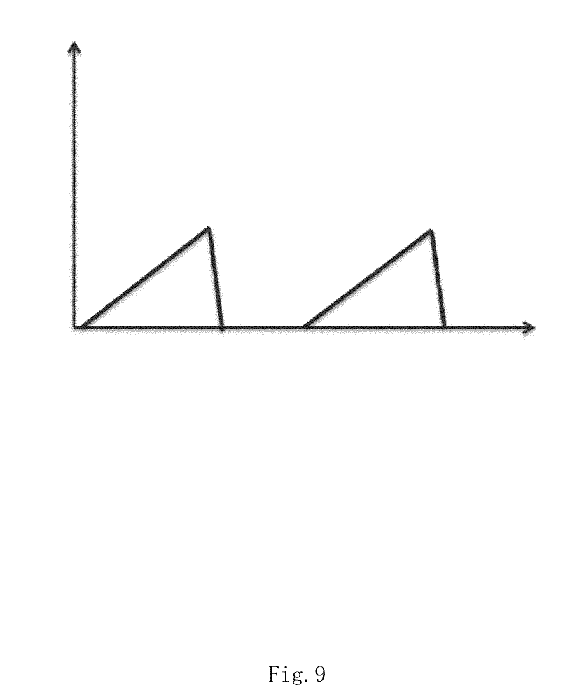

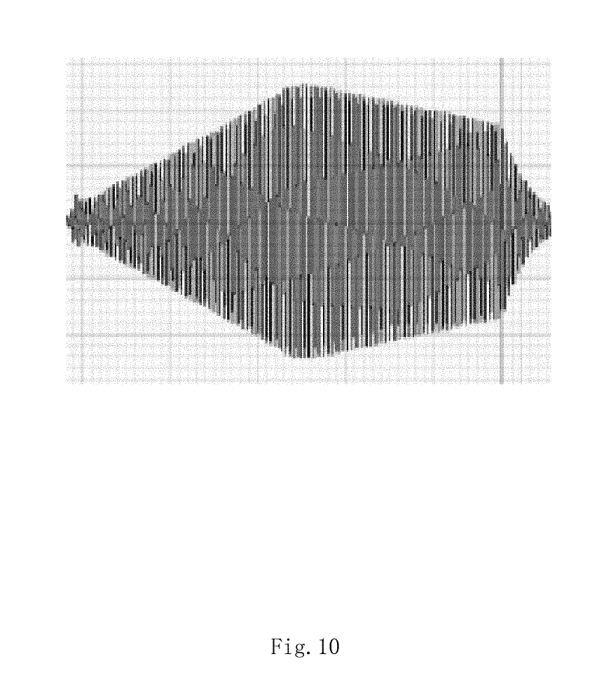

When the line drawn by users is a combination line 1 as shown in FIG. 8, the waveform figure of an acceleration as shown in FIG. 9 is generated through the function relationship of the amplitude and duration of the acceleration, Due to the combination line 1 slowly rises firstly and then falls equably, and drops finally, users would experience the vibration with such a sequence: slowly enhance, equably decrease and the intensity of vibration rapidly drops to zero. When the line drawn by users is the combination line 1 as shown in FIG. 10, the waveform figure of an acceleration shown in FIG. 10 is generated through the function relationship of the amplitude and duration of the acceleration, Due to the combination line 2 is a loop line which equably rises firstly and then rapidly drops, correspondingly, the waveform figure of the acceleration is a loop waveform which equably rises firstly and then rapidly drops, users would tautologically experience the vibration with such a sequence: equably enhance and then the intensity of vibration rapidly drops to zero. Obviously, the effect of vibration is completely different after combination, the combination includes such combinations: straight line combines with straight line, and straight line combines with curve, and so on. How to combine is absolutely decided by users, and users would obtain a lot of different vibration experiences.

The motor characteristic physical quantity for representing vibration sense is obtained through the figure drawn by users and according to the position relationship on a screen and the length of the figure. The motor characteristic physical quantity would change with the change of the length and the position relationship on a screen of the figure. The motor characteristic physical quantity is used to generate electrical signal for driving motor, the change rule of the electrical signal is consistent with the change rule of the vibration characteristic physical quantity, finally, the generated electrical signal is stored as a custom vibration sense corresponding to the figure. Due to the electrical signal is voltage or electricity which changes over time, thus the electrical signal represents as functional relationship of time and the waveform of the electrical signal could be drawn. Due to the change rule of the electrical signal waveform is corresponding with the change rule of the figure drawn by users, through the electrical signal drives the motor, the motor could provide custom vibration sense with different vibration intensity.

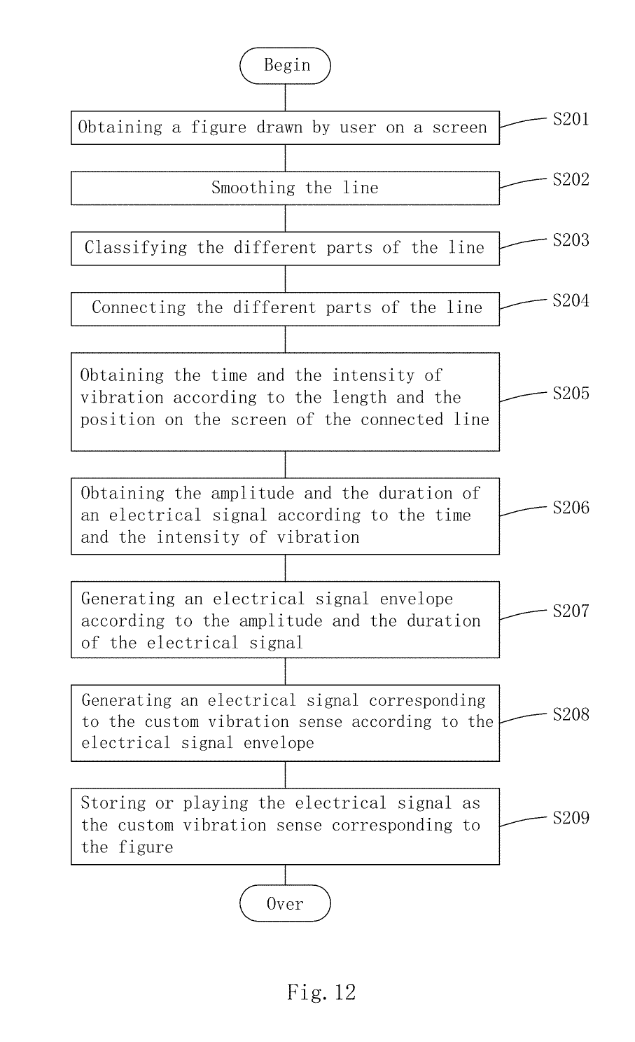

Embodiment 2 of the present disclosure relates to a method of custom vibration sense, the embodiment 2 is almost the same as the embodiment 1, the difference between the embodiment 2 and the embodiment 1 is: in the embodiment 1, the vibration characteristic physical quantity is acceleration envelope, but in the embodiment 2, the vibration characteristic physical quantity is electrical signal envelope. Therefore, in the embodiment 2, the electrical signal is easy to be transported and controlled, the characteristic physical quantity of the electrical signal envelop is used to generate the electrical signal for driving a motor, thus users can precisely convert the electrical signal to vibration needed by users according to the figure drawn by users. The detailed flow diagram of the embodiment 2 shown as FIG. 12, includes:

S201: obtaining a figure drawn by user on a screen.

S202: smoothing the line.

S203: classifying the different parts of the line.

S204: connecting the different parts of the line.

S205: obtaining the time and the intensity of vibration according to the length and the position on the screen of the connected line.

The step S201 to the step S205 is similar to the step S101 to the step S105, the purpose is to: obtain the figure drawn by users on a screen; smooth the figure; Classify the different parts of the line; Connect the different parts of the line; and obtain the time and the intensity of vibration according to the length and the position on the screen of the connected line, and not explained here.

S206: obtaining the amplitude and the duration of an electrical signal according to the time and the intensity of vibration.

Specifically, in the step S206, the time of vibration is correspond with the duration of the electrical signal, for example, one centimeter means 500 milliseconds, therefore, users draw a four centimeters line that means the vibration time is two seconds, the intensity of vibration is correspond with the amplitude of the electrical signal. First, the intensity of vibration is determined by determining the different position of the lines on a screen, and then the amplitude of the electrical signal is obtained according to the intensity of vibration, such as the upper area of the screen correspond with the vibration sense is 2 Vrms (effective voltage value of sin AC signals), the central area is 1.5 Vrms, and so on. Users can pre-set the vibration intensity correspond with the different position on the screen according to need, and then the absolutely different vibration sense experience generates.

S207: generating an electrical signal envelope according to the amplitude and the duration of the electrical signal.

Specifically, in the step S207, the waveform is drawn through the functional relationship of the amplitude and the duration of the electrical signal, and the electrical signal envelope is generated by finding the geometric position of each point in the phase and connecting the trajectories of these points.

S208: generating an electrical signal corresponding to the custom vibration sense according to the electrical signal envelope.

Specifically, in the step S208, the electrical signal can be generated through the electrical signal envelope, also can be generated through the combination of the electrical signal envelope, a motor and other characteristic physical quantity of the motor system.

S209: storing or playing the electrical signal as the custom vibration sense corresponding to the figure.

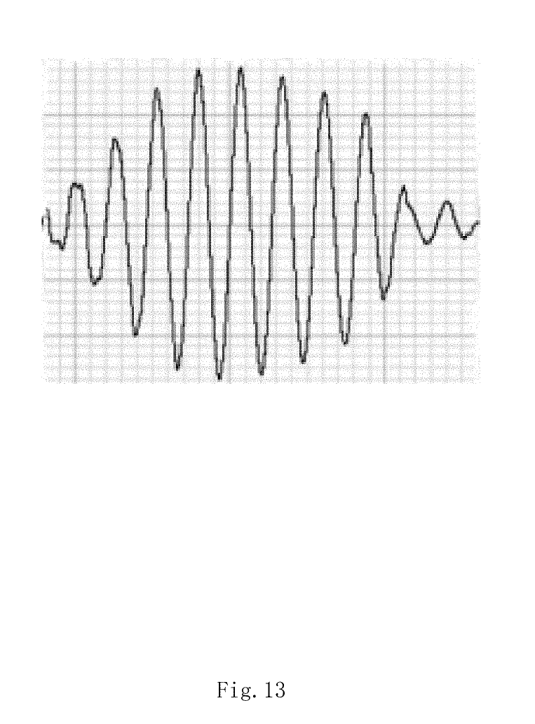

The embodiment 2 of the present disclosure will hereinafter be described in detail. When the line drawn by users is the line as shown in FIG. 3, the waveform figure of the electrical signal shown in FIG. 13 will be generated according to the functional relationship of the amplitude and the duration of the electrical signal, and the users can clearly feel uniformly rising and falling of the vibration intensity. Obviously, if the curve is different, the electrical signal is different corresponding to the curve, of course, the realistic vibration sense is also different.

Technicist in this field understand that, in the embodiment 2 of the present disclosure, the vibration characteristic physical quantity for characterizing vibration sense is obtained through the figure drawn by users according to the length and the position relationship on the screen of the figure. The vibration characteristic physical quantity would change with the change of the length and the position relationship on the screen of the figure. The vibration characteristic physical quantity is used to generate electrical signal for driving motor, the change rule of the electrical signal is consistent with the change rule of the vibration characteristic physical quantity, finally, the generated electrical signal is stored as a custom vibration sense corresponding to the figure. Due to the electrical signal is voltage or electricity which changes over time, thus the electrical signal represents as functional relationship of time and the waveform of the electrical signal could be drawn. Due to the change rule of the electrical signal waveform is corresponding with the change rule of the figure drawn by users, through the electrical signal drives the motor, the motor could provide custom vibration sense with different vibration intensity.

Above steps division of various methods, which is just for describing in detail, being combined into one step or take apart for some steps when to realize, being decomposed into several steps, as long as including the same logic relations, are all within the scope of protection of the present invention. Adding insignificant modifications to an algorithm or process or introducing irrelevant design without changing its algorithm or the core design of the process are within the scope of protection of the present disclosure.

The embodiment 3 of the present disclosure relates to a device of custom vibration sense, comprising:

At least one processor 301; and

A storage 302 communicated with the at least one processor 301;

Wherein the storage 302 stores instruction which may be executed by the at least one processor 301, the instruction is executed by the at least one processor 301 so that the at least one processor 301 can execute the method of custom vibration sense of embodiment 1 or embodiment 2.

Wherein, the storage 302 and the processor 301 is connected by bus, and the bus can include any number of interconnected buses and bridges, and the bus connect the various circuits of one or more of the processor 301 and the storage 302. The bus further connects various circuits tighter, such as the circuit of peripheral equipment, voltage regulator and power management circuit, etc, these are known in this field. Therefore, this article is no longer on the further description. The bus interface provides an interface between the bus and a transceiver. The transceiver can be a single component or multiple components, such as multiple receivers and transmitters, and the transceiver is used to provide a unit for communicating with various other devices on the transmission medium. The data processed by the processor 301 is transmitted through an antenna on the a wireless medium. Furthermore, the antenna also receives the data and transmits the data to the processor 301.

The processor 301 manages the bus and normal processing, and also provides a variety of functions, including timing, peripheral interfaces, voltage regulation, power management, and other control functions. The storage 302 can be used to store the data that the processor 301 uses when performing operations.

The embodiment 4 of the present disclosure relates to a computer readable storage medium, which is stored with a computer program. Implement the above method implementation example when a computer program is executed by the processor.

It is to be understood that, the realization of the above steps to implement all or part of the case method can be done through program instruction related to hardware, the program is stored in a storage medium, including several instructions to make a device (can be a single chip, chip, etc.) or processor mentioned in this application the example method of all or part of the process. And the storage medium includes: U disk, mobile hard disk, ROM (Read-Only Memory), RAM (Random Access Memory), disk or CD and other medium can store the program code.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A method of custom vibration sense, comprising the following steps:
Obtaining a figure drawn by users on a screen;
Obtaining a vibration characteristic physical quantity for characterizing vibration sense according to the figure;
Generating an electrical signal for driving a motor according to the vibration characteristic physical quantity;
Storing or playing the electrical signal as a custom vibration sense correspond with the figure.

2. The method of claim 1, wherein the figure is a line; The step for obtaining a vibration characteristic physical quantity for characterizing vibration sense according to the figure, specifically comprises:
Obtaining the time and the intensity of vibration according to the length and the position on the screen of the line;
Generating a driving signal correspond with a motor according to the time and the intensity of vibration.

3. The method of claim 2, wherein the step for obtaining the time and the intensity of vibration according to the length and the position on the screen of the line, specifically comprises:
Smoothing the line;
Classifying the different parts of the line;
Connecting the different parts of the line;
Obtaining the time and the intensity of vibration according to the length and the position on the screen of the line after connection.

4. The method of claim 3, wherein the step for generating a vibration characteristic physical quantity according to the time and the intensity of vibration, specifically comprises:
Obtaining the amplitude and the duration of an acceleration according to the time and the intensity of vibration;
Generating an acceleration envelope according to the amplitude and the duration of the acceleration;
Considering the acceleration envelope as the vibration characteristic physical quantity.

5. The method of claim 3, wherein the step for generating a vibration characteristic physical quantity according to the time and the intensity of vibration, specifically comprises:
Obtaining the amplitude and the duration of an electrical signal according to the vibration time and the vibration intensity;
Generating an electrical signal envelope according to the amplitude and the duration of the electrical signal;
Considering the electrical signal envelope as the vibration characteristic physical quantity.

6. The method of claim 5, wherein the custom line specifically comprises:
point, straight line, curve or polyline.

7. A device of custom vibration sense, comprising:
At least one processor; and
A storage communicated with the at least one processor;
Wherein the storage stores instruction which may be executed by the at least one processor, the instruction is executed by the at least one processor so that the at least one processor can execute the method of custom vibration sense of claim 1.

8. A computer readable storage medium, stored a computer program, wherein the computer program is executed by the processor for realizing the method of custom vibration sense of claim 1.
